(19) United States
(12) Patent Application Publication
(10) Pub. No.: US 2009/0045173 A1
(43) Pub. Date: Feb. 19, 2009

(54) STUD WELDER CHUCK ASSEMBLY

(75) Inventors: Clark Champney, Vermillion, OH (US); Altin Gjergo, Rocky River, OH (US); Phillip Maria, Ashland, OH (US)

Correspondence Address: GIFFORD, KRASS, SPRINKLE,ANDERSON & CITKOWSKI, P.C, PO BOX 7021, TROY, MI, 48007-7021, US

(73) Assignee: Nelson Stud Welding, Inc., Elyria, OH (US)

(21) Appl. No.: 12/031,120

(22) Filed: Feb. 14, 2008

Related U.S. Application Data
(60) Provisional application No. 60/889,993, filed on Feb. 15, 2007.

(51) Int. Cl. B23K 11/04

(52) U.S. Cl. 219/100; 219/98

(57) ABSTRACT

A chuck assembly for a stud welding gun includes a current passing member parallel to and separated from an electrically isolated member forming a stud retaining gap. The current passing member provides a path for a welding current and includes a contact surface for releasably retaining and transmitting the welding current through a shank of a weld stud. The welding current only passes through the current passing member into the shank of the stud.

### CROSS-REFERENCE TO RELATED APPLICATIONS

This application claims priority benefit of U.S. provisional patent application No. 60/889,993 filed on Feb. 15, 2007 and is herein incorporated by reference.

### FIELD OF THE INVENTION

The invention relates to stud welding guns and chuck assemblies for stud welding guns.

### BACKGROUND OF THE INVENTION

Chucks for stud welding guns are generally known in the art. Various studs may be held by chucks designed for that type of stud. Punching Shear Resistor (PSR) Studs may be used to fabricate reinforcing rails for concrete floor slabs and foundations at the point where columns penetrate through the floor to prevent “punching shear.” The PSR studs significantly reduce the need for heavy reinforcement and a large column capital under the floor slab. The PSR studs provide easier installation and ductile performance. Generally, several studs of an established length and diameter are welded onto a flat bar at specific spacing to extend from the column perimeter into the floor slab. This reduces the amount of reinforcing bar required in an area and column reinforcing congestion resulting in lower overall costs. PSR studs typically include a relatively narrow elongated shank and thin widened head. Due to the size characteristics and thin head of the PSR stud it is difficult to manufacture heads that have a consistent head circumference or a flat on the outside circumference.

Sleeve type chucks are generally known in the art and grip on the outside circumference of the heads of shear connector and concrete anchor studs. These types of chucks require the heads of the studs to have a flat surface and a consistent outside circumference. Due to the manufacturing difficulties outlined above, attempting to grip on the outside circumference of the heads of PSR studs is not consistent and leads to potential problems in a welding operation.

Side gripping chucks are also generally known in the art and are typically made of conductive copper alloys. The bodies of these chucks include only one conductive face. If the conductive face is damaged by electrical arcing the chuck body needs to be replaced. The cost of replacing such chuck bodies is significant.

There is therefore a need in the art for a welding chuck for PSR and similar studs that allows for reliable gripping and electrical contact in a weld gun. Additionally, there is a need in the art for a welding chuck that may be easily and economically refurbished or have worn components replaced after repeated welding operations. There is a further need in the art for a process of welding PSR and similar studs that provides a reliable and cost efficient welding procedure.

### SUMMARY OF THE INVENTION

In one aspect there is disclosed a chuck assembly for a stud welding gun that includes a current passing member parallel to and separated from an electrically isolated member forming a stud retaining gap. The current passing member providing a path for a welding current and including a contact surface for releasably retaining and transmitting the welding current through a shank of a weld stud. The welding current only passes through the current passing member into the shank of the stud.

In another aspect, there is disclosed chuck assembly for a stud welding gun that includes a punching shear resistor stud. A current passing member is parallel to and separated from an electrically isolated member forming a stud retaining gap. The current passing member provides a path for a welding current and includes a contact surface for releasably retaining and transmitting the welding current through a shank of the punching shear resistor stud. The welding current only passes through the current passing member into the shank of the punching shear resistor stud.

In another aspect, there is disclosed a process for welding a punching shear resistant stud including the steps of: providing a welding gun having a chuck assembly having a current passing member parallel to and separated from an electrically isolated member forming a stud retaining gap, the electrically isolated member including a moveable biasing member; positioning a punching shear resistant stud such that a shank of the stud is pushed between the current passing member and the biasing member against a biasing force of the biasing member wherein the shank is retained securely against the current passing member and is aligned properly with the chuck assembly; contacting the stud to a surface of a part to be welded; lifting the stud from the surface of the work piece; energizing the weld gun providing a current through the current passing member into the shank forming an arc between a tip of the stud and the work piece; and melting the work piece and stud; and plunging the stud into the work piece forming a weld joint between a part to be welded and the stud.

### BRIEF DESCRIPTION OF THE DRAWINGS

FIG. 1 is an exploded perspective view of one embodiment of a chuck;

FIG. 2 is an assembled perspective view of a chuck;

FIG. 3 is a perspective view of a weld gun having a chuck installed on the gun;

FIG. 4 is an exploded perspective view of one embodiment of a chuck;

FIG. 5 is an assembled perspective view of a chuck;

FIG. 6 is an assembled perspective view of a chuck;

FIG. 7 is an assembled perspective view of a chuck including a stud;

FIG. 8 is an assembled perspective view of a chuck including a stud.

### DETAILED DESCRIPTION OF THE PREFERRED EMBODIMENTS

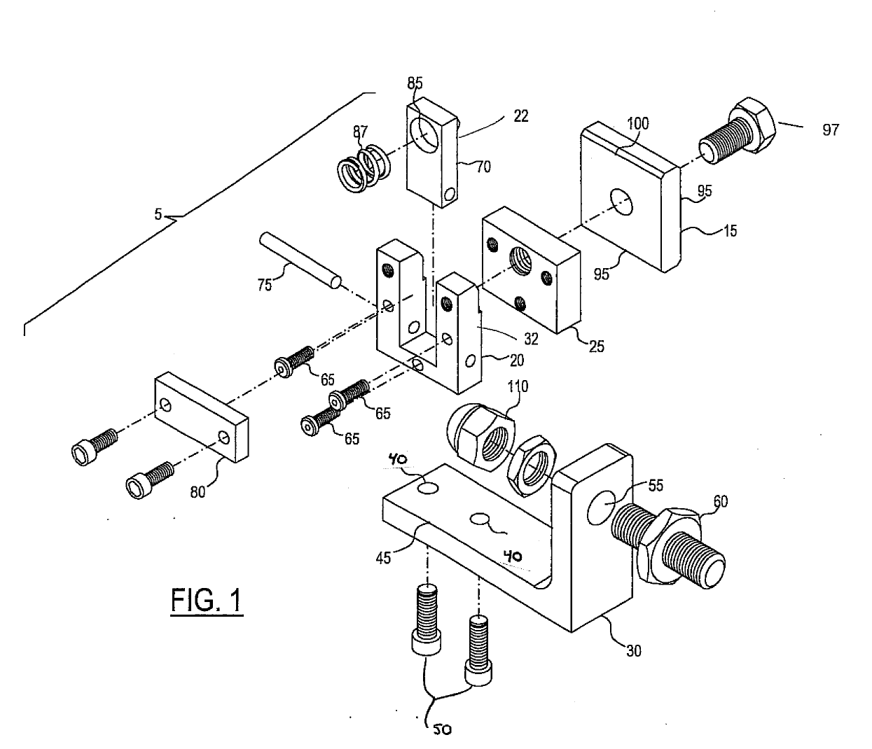

Referring to FIGS. 1-3, there is shown a first embodiment of a chuck assembly 5 for use with a weld stud 10. The chuck assembly 5 includes a current passing member 15 separated from an electrically isolated member 20 by a spacer 25 forming a stud retaining gap 27. The spacer 25 may be attached to a mounting bracket 30 that can be attached to a weld gun 35. As seen in the figures, the mounting bracket 30 may be an L-shaped bracket having holes 40 drilled in a surface 45 that receive fasteners 50 to mount the spacer 25 on the mounting bracket 30. On the other depending leg of the mounting member 30, there is also a slot 55 formed therein that may receive a double-ended bolt 60 for attaching the chuck assembly 5 to a weld gun 35 and for transmitting a weld current, as will be discussed in more detail below.

The current passing member 15 may be attached to the spacer 25 using a suitable fastener and corresponding slot formed in the spacer 25. The electrically isolated member 20 may also be attached to the spacer 25 through a plurality of slots formed in the spacer 25 and the electrically isolated member 20 allowing fasteners 65 to extend and attach the electrically isolated member 20 to the spacer 25. The electrically isolated member 20 may be a support bracket 32 having a generally U-shaped body. In one aspect the support bracket 32 may be formed of an insulating or non-conductive material.

A moveable biasing member 70 may be associated with the electrically isolated member 20. The biasing member may be positioned within the U-shaped body of the support bracket 32 and may be pivotally attached to the electrically isolated member 20 via a pivot pin 75 constrained by the support bracket 32 allowing pivotal movement of the biasing member 70 relative to the electrically isolated member 20 to allow for a biasing force to be placed upon a weld stud 10 when placed in the chuck assembly 5, as will be described in more detail below. In one aspect, the biasing member may include a notch 22 that may be sized to retain the shank 90 of the stud. It should be understood that other biasing members such as compressible legs or other compressible features may alternatively be utilized.

A retaining member 80 may be spaced from the biasing member 70 and be attached to the electrically isolated member 20. The retaining member 80 may include a recess or pocket 85 formed thereon for receiving a biasing spring 87 that is also seated in a recess or pocket 85 formed on the biasing member 70. In this manner, the biasing member 70 may be biased toward the current passing member 15 to place a retaining force on the shank 90 of a stud 10 positioned within the chuck assembly 5.

In one aspect, the current passing member 15 includes a planar or flat surface 95 for engaging with the shank 90 of a stud 10 positioned within the chuck assembly 5. The planer surface 95 provides an electrical contact with the shank 90 to transmit a weld current through the stud 10 in a stud welding operation. In one aspect, the weld current is transmitted through the shank 90 of the stud 10 and only passes through the current passing member 15. In this manner, the electrically isolated member 20 does not pass a weld current preventing wear and necessary replacement of the component improving the overall cost of the weld chuck assembly 5. Additionally, the passing of a welding current through only the current passing member 15 allows for improved control of the current for a welding operation.

In one aspect, the current passing member 15 may be in the form of a rectangular body having opposing planar surfaces 95. The edges 100 along the planar surfaces 95 may be chamfered to allow for insertion and withdrawal of the shank 90 of a stud positioned between the current passing member 15 and the biasing member 70. In one aspect, the rectangular body may be rotated if an arc formed between the weld stud 10 and current passing member 15 erodes or wears away a portion of the planar surface 95 such that rotation of the current passing member 15 provides another portion of the planar surface 95 to contact a shank 90 positioned within the chuck assembly 5. In this manner, each side of the current passing member 15 if it is rectangular may include four quadrants allowing for rotation of each side of the current passing member 15 allowing eight different contact surfaces for both planar surfaces 95. Additionally, the planar surfaces 95 of the current passing member 15 can be machined or sanded down following erosion or wear due to arcing thereby refurbishing the current passing member 15 in an efficient manner.

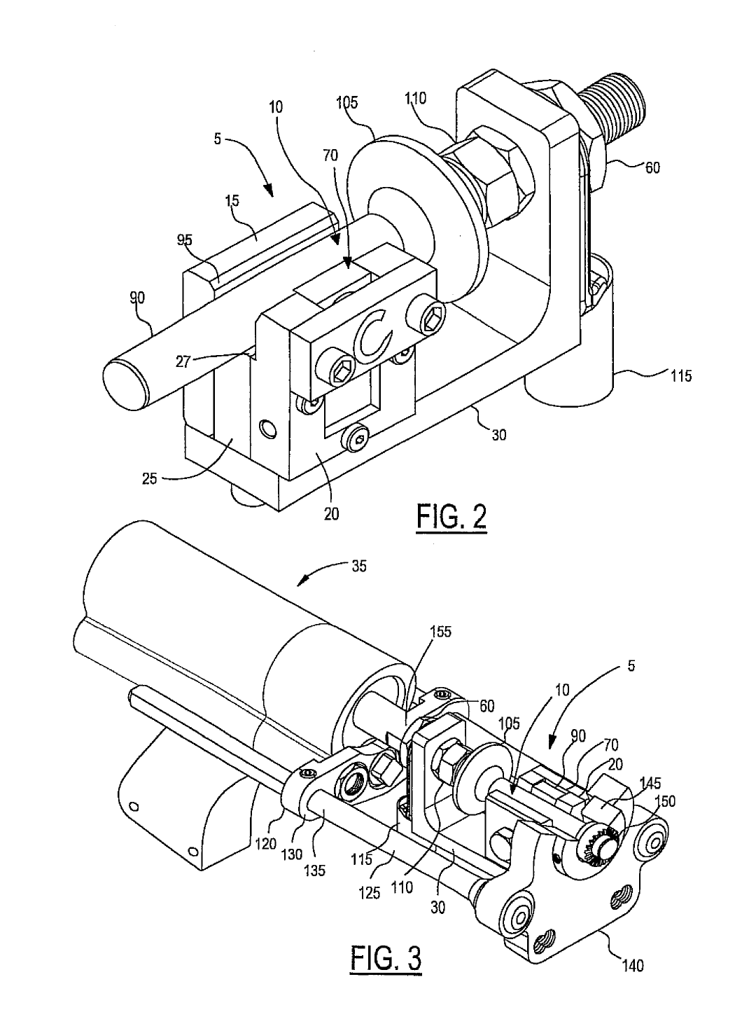

Referring to FIG. 2, there is shown an assembled chuck assembly 5 including a stud shank 90 positioned within the chuck assembly 5. As can be seen in the figure, the head 105 of the stud 10 is in contact with a nonconductive nut 110 that is attached to the double-ended bolt 60 positioned in the slot 55 formed in the mounting bracket 30. A power cable 115 may be attached to the double-ended bolt 60 and conduct a current through the mounting bracket 30 and into the current passing member 15 for transmission through a shank 90 of the weld stud 10. In another aspect, the power cable 115 may be directly coupled to the current passing member 15 using a fastener 97 (best seen in FIG. 1) such that the weld current can be sent through the current passing member 15 directly. The shank 90 of the stud 10 is positioned between the planar surface 95 of the current passing member 15 and the biasing member 70 pivotally coupled to the electrically isolated member 20. The spring 87 biases the biasing member 70 into contact with the shank 90; thereby assuring alignment of the stud 10 within the gap 27 between the current passing member 15 and the electrically isolated member 20 defined by the spacer 25. Additionally, the biasing member 70 biases the shank 90 of the stud 90 into contact with the planar surface 95 of the current passing member 15 minimizing arcing between the shank 90 of the stud 10 and the current passing member 15. The spacer 25 may have varying thicknesses to accommodate various diameter shanks 90 of studs 10.

Referring to FIG. 3, there is shown a weld gun 35 including a foot assembly 120 attached to the front end of the weld gun 35. As shown in the depicted embodiment, the foot assembly 120 includes an adapter 130 mounted to the front of the weld gun 35 and provides slots 135 formed in the adapter 130 to receive the legs 125 of the foot assembly 120. The foot assembly 120 includes spaced legs 125 for accommodating the head 105 of the weld stud 10. The foot assembly 120 may also include a foot 140 that is formed of an insulating material which holds a ferrule holder 145 to retain or hold a ferrule 150 about an end of the shank 90 of the weld stud 10 to contain the pool of molten metal formed during the welding operation and ensure a quality weld between the weld stud 10 and a part to be welded.

The support member 130 may be attached to a lift and plunging member 155 of the weld gun 35 which supplies the current through the double-ended bolt 60, as well as moves the chuck assembly 5 into lift and plunge positions during a stud welding operation. The shank 90 of the weld stud 10 may be positioned along spacer 25 between the current passing member 15 and the biasing member 70 such that the shank 90 is aligned with the planar surface 95 of the current passing member 15 to minimize arcing between the components. The welding current for the welding operation is supplied through the current passing member 15 directly to the shank 90.

In operation, a stud 10 may be positioned such that the shank 90 is pushed between the current passing member 15 and the biasing member 70 against the biasing force of the spring 87. The shank 90 is then retained securely against the current passing member 15 and is aligned properly along the spacer 25 due to the biasing force applied by the biasing member 70. The stud 10 may then be contacted to a surface of a part to be welded wherein the weld gun 35 lifts the stud 10 from the surface of the work piece and energizes providing a current through the current passing member 15 into the shank 90 forming an arc between the tip of the stud 10 and the work piece; thereby melting the work piece and stud 10. Following the melting, the stud 10 is plunged into the work piece and the molten pool captured by the ferrule 150 forms a weld joint between a part to be welded and the stud 10. It should be realized that the process described may be performed without the ferrule 150. The shank 90 of the stud 10 may then be removed from between the current passing member 15 and the biasing member 70 by angling the weld gun 35 allowing the shank 90 to slip from between the current passing member 15 and the biasing member 70 against the biasing force of the spring 87.

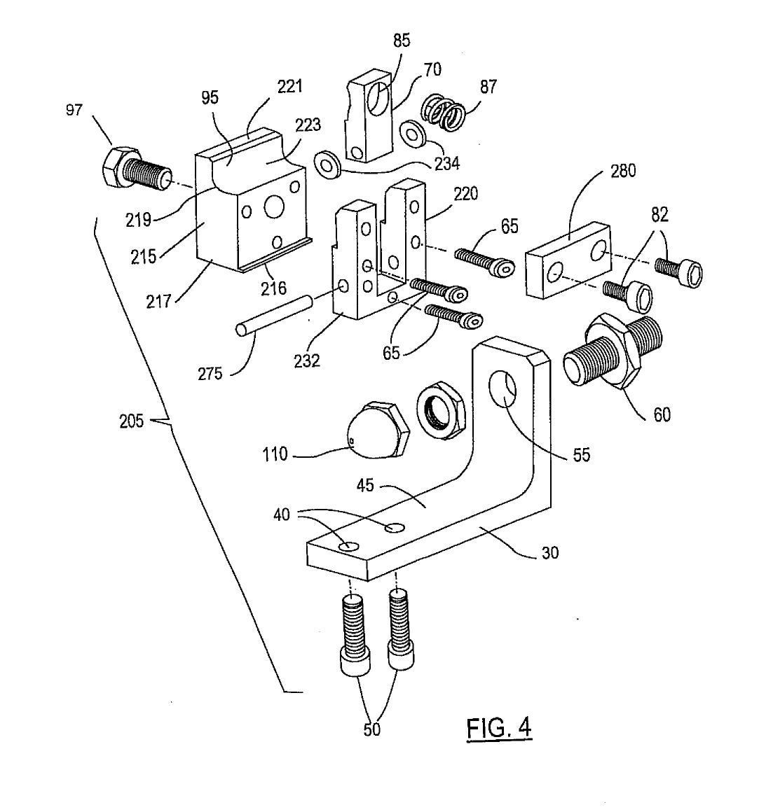

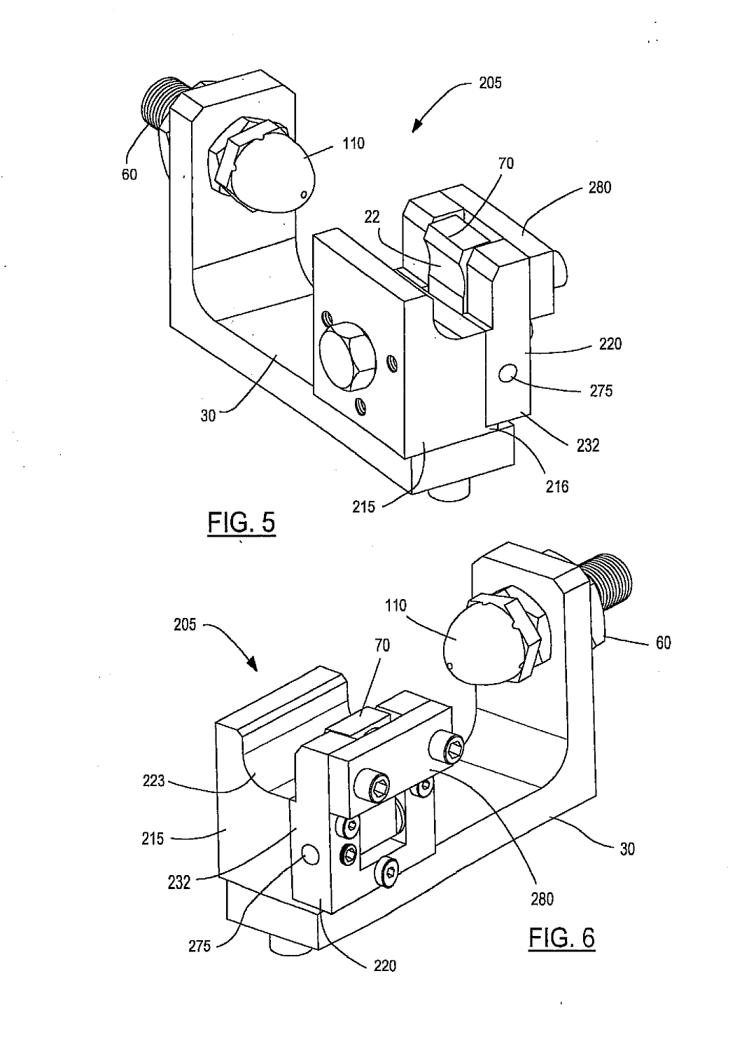

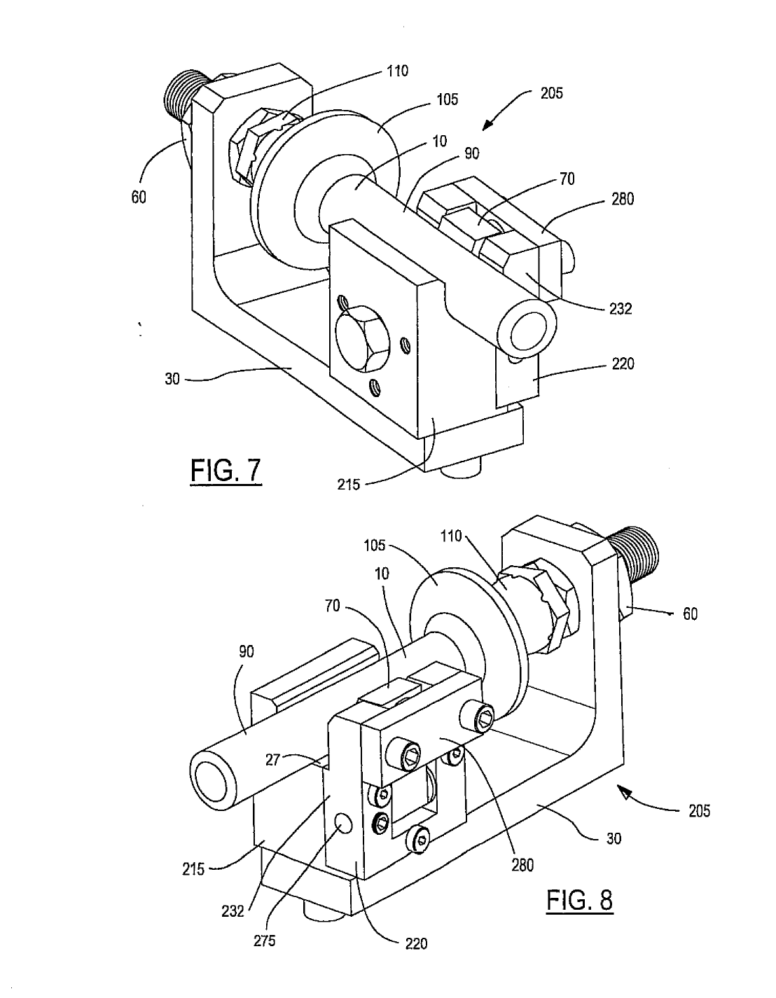

Referring to FIGS. 4-8 there is shown an alternative embodiment of a weld chuck assembly 205. The weld chuck assembly 205 includes the mounting bracket 30, and biasing member 70 as described above. Various modifications to the other components such as the, current passing member 215, electrically isolated member 220 having a support bracket 232 will be described below. The spacer 25 described above in the first embodiment has been removed.

The current passing member 215 may be attached to the mounting member 30 as described above. The electrically isolated member 220 including the support bracket 232 may be attached to the current passing member 215 instead of to the spacer 25, as described above. The current passing member 215 includes a generally rectangular body 217 having a profile 219 formed thereon. The profile 219 starts at a top surface 221 of the body 217 and extends lineally downward to a radius 223 to form a contact surface 95 as was previously described above. The contact surface 95 includes the radius 223 allowing for a greater contact area between the shank 90 of a stud 10 and the current passing member 215. As previously described above, the current passing member 215 may include a chamfered edge 100 allowing insertion and withdrawal of the shank 90 of a stud 10 positioned between the current passing member 215 and the electrically isolated member 220.

The electrically isolated member 220 including the support bracket 232 has a similar U-shape as described above. The support bracket 232 may be formed of a conductive material. The biasing member 70 may be positioned within the U-shaped body of the support bracket 232 and may be pivotally attached to the electrically isolated member 220 via a pivot pin 275 constrained by the support bracket 232 allowing pivotal movement of the biasing member 70 relative to the electrically isolated member 220 to allow for a biasing force to be placed upon a weld stud 10 when placed in the chuck assembly 205. A retaining member 280, as described above may also be spaced from the biasing member 70. In one aspect, the pin 275 and retaining member 280 may be formed of a non-conducting material. Additionally, the support bracket 232 may include non-conductive washers 234 positioned between the biasing member 70 and support bracket 232 about the pin 275. The non-conductive washers 234 prevent transmission of the weld current from the biasing member 70 into the support bracket 232. The current passing member 215 includes a ledge 216 formed thereon for spacing the support bracket 232 above the mounting member 30. In this manner, while the support bracket may be formed of a conducting material having the same potential as the current passing member 215, but there is no path for the weld current other than the current passing member 215. The non-conducting pin 275, non-conducting retaining member 280 and spacing of the support bracket 232 above the mounting member 30 electrically isolates the support bracket 232.

As described above, the weld current is transmitted through the shank 90 of the stud 10 and only passes through the current passing member 215. In this manner, the electrically isolated member 220 does not pass a weld current preventing wear and necessary replacement of the component improving the overall cost of the weld chuck assembly 205. Additionally, the passing of a welding current through only the current passing member 215 allows for improved control of the current for a welding operation.

The invention has been described in an illustrative manner. It is to be understood that the terminology, which has been used, is intended to be in the nature of words of description rather than limitation. Many modifications and variations of the invention are possible in light of the above teachings. Therefore, within the scope of the appended claims, the invention may be practiced other than as specifically described.

1. A chuck assembly for a stud welding gun comprising:
a current passing member parallel to and separated from an electrically isolated member forming a stud retaining gap, the current passing member providing a path for a welding current and including a contact surface for releasably retaining and transmitting the welding current through a shank of a weld stud wherein the welding current only passes through the current passing member into the shank of the stud.

2. The chuck assembly of claim 1 wherein the electrically isolated member includes a moveable biasing member urging the shank of the stud into contact with the current passing member.

3. The chuck assembly of claim 2 wherein the electrically isolated member includes a support bracket having a pin constrained by the support bracket and pivotally retaining the biasing member.

4. The chuck assembly of claim 3 including a retaining member spaced from the biasing member and attached to the support bracket, the retaining member including a recess formed therein and receiving one end of a biasing spring, the other end of the biasing spring retained in a recess formed in the biasing member.

5. The chuck assembly of claim 3 including a mounting member, the current passing member attached to the mounting member.

6. The chuck assembly of claim 5 including a spacer attached to the current passing member and the support bracket attached to the spacer, the spacer defining the stud retaining gap.

7. The chuck assembly of claim 6 wherein the spacer is replaceable and of a variable predefined size thereby defining the size of a gap into which a shank of a stud of variable predefined size may be side loaded to provide a gripping engagement between the current passing member and the shank of the stud allowing for transmission of an electrical current from the current passing member through the shank of the stud for a stud welding operation.

8. The chuck assembly of claim 3 wherein the support bracket is formed of a non conductive material.

9. The chuck assembly of claim 2 wherein the biasing member includes a notch sized to retain the shank of the stud.

10. The chuck assembly of claim 1 wherein the current passing member includes chamfered edges allowing insertion and withdrawal of the shank of a stud positioned between the current passing member and the electrically isolated member.

11. The chuck assembly of claim 5 wherein the current passing member includes a body having a profile formed thereon, the profile starting at a top surface of the body and extending downward to a radius, the profile defining the contact surface.

12. The chuck assembly of claim 11, wherein the support bracket is attached to the current passing member.

13. The chuck assembly of claim 12 wherein the support bracket is formed of a conductive material, the retaining member and pin formed of a non-conductive material.

15. The chuck assembly of claim 14 wherein the current passing member includes a ledge formed thereon for spacing the support bracket above the mounting member.

16. The chuck assembly of claim 12 the support bracket including non conductive washers positioned between the biasing member and support bracket about the pin.

17. A chuck assembly for a stud welding gun comprising:
a punching shear resistor stud;
a current passing member parallel to and separated from an electrically isolated member forming a stud retaining gap, the current passing member providing a path for a welding current and including a contact surface for releasably retaining and transmitting the welding current through a shank of the punching shear resistor stud wherein the welding current only passes through the current passing member into the shank of the punching shear resistor stud.

18. A process for welding a punching shear resistor stud including the steps of:
providing a welding gun having a chuck assembly having a current passing member parallel to and separated from an electrically isolated member forming a stud retaining gap, the electrically isolated member including a moveable biasing member;
positioning a punching shear resistor stud such that a shank of the punching shear resistor stud is pushed between the current passing member and the biasing member against a biasing force of the biasing member wherein the shank is retained securely against the current passing member and is aligned properly with the chuck assembly;
contacting the stud to a surface of a part to be welded;
lifting the stud from the surface of the work piece;
energizing the weld gun providing a current only through the current passing member into the shank forming an arc between a tip of the stud and the work piece; and melting the work piece and stud;
plunging the stud into the work piece forming a weld joint between a part to be welded and the stud.

19. The process of claim 18 further including the step of providing a ferrule about the tip of the stud capturing the molten pool formed in the energizing step.

20. The process of claim 18 further including the step of removing the shank of the stud from between the current passing member and the biasing member by angling the weld gun allowing the shank to slip from between the current passing member and the biasing member against the biasing force.
